(19) United States
(12) Patent Application Publication
(10) Pub. No.: US 2017/0055133 A1
(43) Pub. Date: Feb. 23, 2017

(54) MULTICAST CONNECTION ADMISSION CONTROL

(71) Applicant: Adtran, Inc., Huntsville, AL (US)

(72) Inventors: Chad Anthony Dieselberg, Madison, AL (US); Nagaraj Padur, Madison, AL (US)

(21) Appl. No.: 14/827,957

(22) Filed: Aug. 17, 2015

(51) Int. Cl. H04W 4/08; H04W 24/10; H04W 48/06; H04W 24/08

(52) U.S. Cl. CPC H04W 4/08; H04W 24/08; H04W 24/10; H04W 48/06

(57) ABSTRACT

Methods and apparatus for multicast connection admission control are disclosed. In one aspect a method includes measuring, at a forwarding plane of a telecommunications device, an actual amount of multicast bandwidth being used to deliver multicast data to multiple end user devices over a telecommunications link; controlling, by the telecommunications device, membership to the multicast table based on the measured amount of multicast bandwidth being used independent of the amount of bandwidth or type of bandwidth used by any individual member of the multicast table and a threshold amount of bandwidth, and transmitting, by the telecommunications device, the multicast data to user devices that have requested the multicast data corresponding to a member of the multicast table.

### BACKGROUND

This specification relates to telecommunications and multicast connection admission control in a telecommunications network.

Multicast video has been widely used by service providers to deliver video programs to viewers. Usually multiple video channels are delivered together on a telecommunication link. Multicast video is extremely sensitive to packet loss. Even a single packet lost in a video stream can cause a noticeable artifact for the viewer.

Due to the sensitivity to packet loss, multicast video is usually prioritized above some other forms of consumer traffic such as Internet. In some situations, various techniques can be used to manage the allocation of bandwidth between multicast video and the other forms of consumer traffic so that bandwidth remains available for the other forms of consumer traffic.

### SUMMARY

In general, one innovative aspect of the subject matter described in this specification can be embodied in methods that include the actions of measuring, at a forwarding plane of a telecommunications device, an actual amount of multicast bandwidth being used to deliver multicast data to multiple end user devices over a telecommunications link; controlling, by the telecommunications device, membership to the multicast table based on the measured amount of multicast bandwidth being used independent of the amount of bandwidth or type of bandwidth used by any individual member of the multicast table and a threshold amount of bandwidth; and transmitting, by the telecommunications device, the multicast data to user devices that have requested the multicast data corresponding to a member of the multicast table.

These and other embodiments can each optionally include one or more of the following features. Methods can include the operations of determining that the measured amount of multicast bandwidth being used exceeds the threshold amount of bandwidth; and activating a threshold crossing alarm (TCA) in response to determining that the measured amount of multicast bandwidth being used exceeds the threshold amount. Activating the TCA can include transmitting data that causes a network management system to generate a visual or audible alarm indication. Methods can also include the operations of determining that the measured amount of multicast bandwidth being used is below the threshold amount; and maintaining the TCA until the measured amount of multicast bandwidth has been below the threshold amount for at least a specified period of time.

The telecommunications link can be a passive optical network (PON); and the multicast data can be video data. Measuring the actual amount of multicast bandwidth being used may include determining a current downstream bandwidth utilization from a multicast gigabit PON encapsulation method (GEM) port. Each member of the multicast table represents a multicast video channel. The type of bandwidth used by individual member of the multicast table is variable bandwidth or constant bandwidth. The threshold amount of bandwidth can be changed at any time.

Methods can also include the operations of preventing new members from being added to the multicast table when the measured amount of multicast bandwidth exceeds the threshold amount of bandwidth; and allowing new members to be added to the multicast table when the measured multicast bandwidth does not exceed the threshold amount of bandwidth. Preventing new members from being added may include discarding join requests from user devices when a multicast channel specified in the join request is not already a member of the multicast table. When the amount of multicast bandwidth being used exceeds the threshold amount of bandwidth, join requests from user devices are accepted when a multicast channel specified in the request is already a member of the multicast table.

Another innovative aspect of the subject matter described in this specification can be embodied in devices that include a forwarding plane that delivers multicast data to multiple end user devices over a telecommunications link; and a control plane that controls delivery of multicast data by the forwarding plane. The forwarding plane measures an actual amount of multicast bandwidth being used to deliver multicast data to multiple end user devices over a telecommunications link and reports the amount of multicast bandwidth being used to the control plane; the control plane controls membership to a multicast table based on the measured amount of multicast bandwidth being used.

These and other embodiments can each optionally include one or more of the following features. The control plane determines that the measured amount of multicast bandwidth exceeds the threshold amount of bandwidth; and activates a threshold crossing alarm (TCA) in response to determining that the measured amount of multicast bandwidth exceeds the threshold amount. The control plane activates the TCA comprises transmitting data that causes a network management system to generate a visual or audible alarm indication. The control plane further determines that the measured amount of multicast bandwidth is below the threshold amount; and maintains the TCA until the measured amount of multicast bandwidth has been below the threshold amount for at least a specified period of time.

The telecommunications link can be a passive optical network (PON); and the multicast data can be video data. The forwarding plane measuring the actual amount of multicast bandwidth being used can include determining a current downstream bandwidth utilization from a multicast gigabit PON encapsulation method (GEM) port. Each member of the multicast table represents a multicast video channel.

The control plane controlling membership to a multicast table based on the measured amount of multicast bandwidth and the threshold amount of bandwidth can also include preventing new members from being added to the multicast table when the measured amount of multicast bandwidth exceeds the threshold amount of bandwidth; and allowing new members to be added to the multicast table when the measured multicast bandwidth does not exceed the threshold amount of bandwidth.

Particular embodiments of the subject matter described in this specification can be implemented so as to realize one or more of the following advantages. The example techniques can permit better control of the amount of multicast bandwidth used, for example, by measuring the actual aggregate amount of multicast bandwidth being used to deliver the multicast data rather than pre-assigning each channel a bit rate and using that assigned bit rate for purposes of mathematically computing the amount of utilized bandwidth. The example techniques can eliminate the need to compute the aggregate multicast bandwidth based on the provisioned bandwidth (i.e., the pre-assigned bandwidth) for each individual channel and eliminate the errors that can be introduced when the actual bit rates of channels differ from their respective provisioned bit rates. As such, the aggregate multicast bandwidth utilized at any given time can be more accurately controlled. The example techniques generate alarms to notify a service provider when the measured aggregate multicast bandwidth exceeds a bandwidth limit.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram showing aspects of an example communications system.

FIG. 2 is a schematic diagram of an example communications system which implements a simplified multicast connection admission control.

FIG. 3 is a diagram showing an example change in the measured amount of multicast bandwidth over time.

FIG. 4 is a flow chart of an example process for measuring the actual amount of utilized multicast bandwidth.

FIG. 5 is a flow chart of an example process for updating a multicast table lock.

FIG. 6 is a flow chart of an example process for clearing a TCA hysteresis timer.

FIG. 7 is a flow chart of an example process for processing an IGMP “join” request.

FIG. 8 is a flow chart of an example process for processing an IGMP “leave” message.

Like reference numbers and designations in the various drawings indicate like elements.

### DETAILED DESCRIPTION

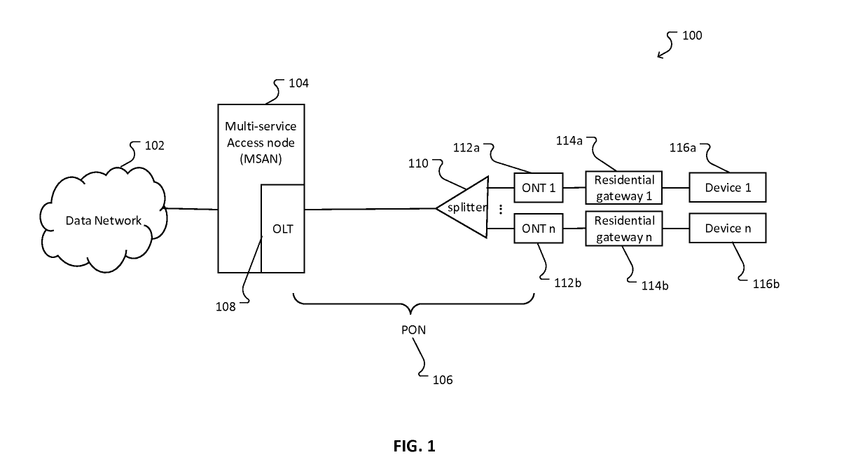

Multicast video has been widely used by service providers to deliver video programs to viewers. Multicast connection admission control (CAC) is used to avoid packet loss to provide good quality of video streams. For example, as discussed in detail with respect to FIG. 1, a simplified multicast CAC can be employed in a communication system to avoid packet loss of video streams.

FIG. 1 is a schematic diagram showing aspects of an example communications system 100. The example system 100 includes a data network 102, a multi-service access node (MSAN) 104 at a service provider's central office (or data center), a passive optical network (PON) (e.g., a gigabit PON (GPON)) 106, residential gateways 114a and 114b at customer premises, and end user devices 116a and 116b that are connected to the residential gateways. The example system 100 can deliver data from the data network 102 to the end user devices 116a and 116b through the PON 106. In some implementations, a communications system can include additional or different components and features and can be configured in different manner than the example system 100 shown in FIG. 1. For example, two residential gateways and two user devices are shown in FIG. 1 for clarity and brevity, but many different residential gateways and/or user devices can be included in the system 100. Similarly, the environment can include multiple MSANs and each MSAN connects to multiple PONs. Furthermore, the communication link between the MSAN 104 and the end user devices 116a and 116b can be different flavors of PON such as GPON, EPON, XGPON, NGPON2 and they may also be other than PON, for example, digital subscriber line (DSL), point-to-point Ethernet and others.

The data network 102 can provide multiple types of traffic data such as Internet, video, Internet Protocol television (IPTV), and voice over Internet Protocol (VoIP). The data network 102 may include data servers, video servers, and other types of servers. In some implementations, the traffic data are packetized into Internet Protocol (IP) packets and distributed to end user devices 116a and 116b.

The MSAN 104 is an aggregation node that delivers multiple types of service over multiple access technologies. For example, the multiple types of service can be traditional voice, VoIP, video, multimedia services, and other services. The multiple access technologies can be Plain Old Telephone System (POTS), Integrated Service Digital Network (ISDN), Asymmetric Digital Subscriber Line (ADSL), VDSL2, Symmetric Digital Subscriber Line (SDSL), Synchronous Digital Hierarchy (SDH), and other access technologies. The MSAN 104 can be located at the service provider's central office, data center or another location. In the example communication system 100, the MSAN 104 connects to the PON 106 to distribute the traffic data to end user devices 116a and 116b. Typically, the MSAN 104 may connect to multiple PONs.

A PON 106 can include an optical line terminal (OLT) 108 within the MSAN 104, a number of optical network terminals (ONTs) 112a and 112b at customer premises, and an optical splitter 110 that enables a single feeder fiber to serve multiple customer premises. The OLT 108 can be at a service provider's central office, data center, or another location. Using the splitter 110, the OLT 108 is coupled to a number of ONTs 112a and 112b that each serves one or more of end users, forming a point-to-multipoint network. For example, in the case of GPON, an OLT card typically includes 16/32 splits onto a single OLT port. This split ratio can vary depending on a number of network design considerations. The point-to-multipoint architecture reduces the amount of fiber and central office equipment required compared with point-to-point architectures.

For GPON, between OLT and ONT the traffic data is encapsulated by GPON encapsulation method (GEM) and the encapsulated frame is transmitted over the fiber between OLT and ONT. To meet quality of service requirements of different types of traffic data, multiple GEM ports are designed between OLT and ONT. Each GEM port is assigned to a different traffic class. For example, one GEM port may be assigned to multicast video traffic, while another GEM port may be assigned to other data traffic.

The example communication system 100 also includes residential gateways 114a and 114b at customer premises and end user devices 116a and 116b such as televisions. In some implementation, the residential gateways 114a and 114b are television set-top boxes connected to the televisions.

The example communications system 100 can be used to deliver multicast data, such as video and television, from the data network 102 to end user devices 116a and 116b through the PON 106. The multicast data carried on the PON 106 can contain multiple video streams or channels. Each multicast video stream or channel can also be called a multicast group. In some implementations, all multicast video data carried on the GPON 106 is associated with one multicast GEM port. Multicast is a technique for one-to-many or many-to-many communication. During multicast, the source sends the packet only once and the intermediate nodes in the network, for example, network switches or routers, replicate the packet to distribute to multiple end user devices. Therefore multicast uses network resources efficiently by having the packet sent only once on each link.

Internet Group Management Protocol (IGMP) is a communication protocol to establish multicast group memberships. In some implementations, the PON 106 does not need to carry data of all the possible video channels (i.e., all the possible multicast groups). Rather, only those channels which are currently requested by the end user devices are sent over the PON 106. To manage the list of channels that are delivered over the PON to associated end user devices, IGMP can be used. For example, if an end user requests to view a channel (e.g., through interaction with a remote control or other tuning device), his/her residential gateway 114a (e.g. set-top box) sends an IGMP “join” request to the OLT 108. If the viewer switches to a different channel, his/her residential gateway 114a sends an IGMP “leave” message for the old channel, followed by an IGMP “join” message for the new channel.

As noted above, the PON 106 carries multiple types of traffic data, such as Internet, multicast data, and VoIP. In some situations, an upper limit is placed on the amount of multicast data (e.g., multicast video data) allowed on the PON 106 to leave room on the PON 106 for other types of traffic data such as Internet traffic. The upper limit on the amount of multicast data can also be specified as an upper limit of the PON bandwidth that is allowed to be used for multicast data. Multicast video is extremely sensitive to packet loss. Even a single packet lost in a video flow can cause a noticeable artifact for the viewer. Therefore the upper limit posed on the multicast video data should be met without dropping video packets.

The upper limit for the multicast bandwidth can be enforced through a CAC technique. Ideally, the multicast bandwidth limit is set high enough to provide enough capacity for multicast video without impacting viewers. In the case when the amount of multicast data does exceed the limit, CAC takes effect and the impact is limited to the viewers who request new video channels that are not already being delivered over the PON 106.

For example, assume that the PON 106 serves homes in a residential community. Some viewers are watching a given channel (channel A) and some others are watching a different channel (channel B). In this case, assume that only the multicast data for channel A and channel B are being carried on the PON 106. Further assume, for purposes of this example, that the multicast bandwidth limit for the PON is reached. In this example, if a new viewer requests a third channel (channel C), his/her request will be denied because channel C is not currently being delivered on the PON 106, and there is no more bandwidth available to deliver the multicast data for channel C. However, if he/she requests channel A or channel B, then he/she will receive the multicast data for the requested channel because it is already being delivered on the PON 106 (i.e., additional multicast bandwidth is not required for the user to receive channel A or channel B). If the multicast bandwidth limit is not exceeded, then new video channels (i.e., channels that are not currently being delivered by the network) are allowed to be joined. However, if the multicast bandwidth limit is reached, then new video channels are prevented from joining. Whether the multicast bandwidth limit is reached or not, existing video channels (i.e., channels that are already being delivered by the network) are always allowed to be joined.

The CAC discussed above requires determining the amount of bandwidth being utilized by the multicast data for channels that are being delivered over the PON, and comparing that utilized bandwidth to the multicast bandwidth limit. In some situations, the amount of bandwidth being used by the multicast data can be determined based on the provisioned bit rate of each channel being delivered over the PON. For example, the multicast bandwidth being used can be based on the aggregate provisioned bit rate of each channel being delivered over the PON. In this example, the provisioned bit rates (e.g., as input by a technician) are used for determining the aggregate bit rate and/or computing the bandwidth being used by the multicast data. When a channel is dropped from the PON and another channel is added, another computation is required based on the provisioned bit rate of the channel dropped and the provisioned bit rate of the channel added. Thus, each time the set of channels included in the PON changes, the utilized bandwidth must be recomputed and is dependent on the bit rate of each individual channel. Additionally, the actual bit rates of each channel may change over time, such that the provisioned bit rates of the channels may not match the actual bit rates being used. As such, the utilized bandwidth computed based on the provisioned bit rates may not be accurate.

In the example communication system 100, a simplified multicast CAC can be implemented. As discussed in more detail below, the simplified CAC can be implemented utilizing the actual aggregate amount of multicast bandwidth (e.g., as measured at the multicast GEM port) being used to deliver the multicast data rather than using a computed bandwidth measure that is based on the amount of bandwidth being provisioned for each individual channel. Using the measured aggregate amount of multicast bandwidth being used eliminates the need to compute the amount of bandwidth being used and eliminates the errors that can be introduced when the actual bit rates of channels differ from their respective provisioned bit rates.

The simplified multicast CAC can be implemented at the PON interface, e.g., the OLT 108 within the MSAN 104 at the service provider's central office. The simplified multicast CAC solution can be initiated by setting a multicast bandwidth limit (also referred to “bandwidth limit”) on the PON interface. In a GPON implementation, the valid range for the multicast bandwidth limit is 0-2400,000 kbps and the upper end of the range is typically set to a much lower value (for example, 500,000 kbps) to reserve bandwidth for other classes of traffic on the link. In some implementations, the simplified multicast CAC can be enabled when IGMP proxy is enabled on the OLT of the PON interface.

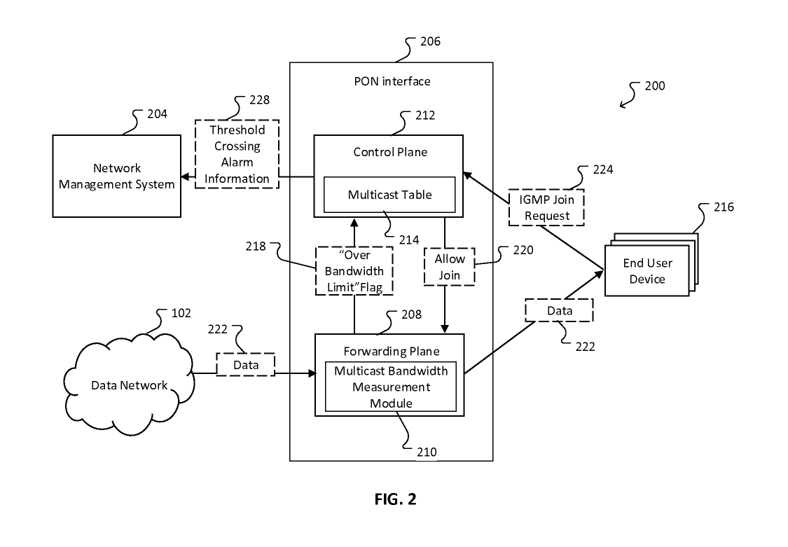

FIG. 2 is a schematic diagram of an example communications system 200 in which a simplified multicast CAC is implemented. The example system 200 includes a data network 102, a network management system 204 which may be located at the service provider's central office, a PON interface 206 which includes a forwarding plane 208 and a control plane 212, and an end user device 216. In some implementations, the PON interface 206 is located at the OLT 108 of FIG. 1. The simplified multicast CAC can be implemented at the PON interface 206 by the forwarding plane 208 and the control plane 212. The forwarding plane 208 delivers the data from the data network 102 to multiple end user devices 216, while the control plane 212 processes the control messages related to multicast data and reports network performance statistics and alarms to the network management system 204. In some implementations, a communications system can include additional or different components and features and can be configured in different manner than the example system 200 as shown in FIG. 2. For example, the PON interface 206 can be connected to the end user device 216 through the splitter 110, the ONT 112a, and the residential gateway 114a, shown in FIG. 1.

The network management system 204 can include various functions to configure, monitor, and maintain operations of a network. The various functions may be related to configuration management, fault management, security management, performance management, accounting management, bandwidth management, and other network management aspects.

The PON interface 206 contains a forwarding plane 208 and a control plane 212. The forwarding plane 208 includes hardware which performs operations including moving multicast data from the data network 102 to the end user device 216 (or from the data network 102 to the fiber link of the PON 106). The control plane 212 includes software (and/or hardware) to make decisions on how to move the packets. Generally, the forwarding plane 208 provides information to the control plane 212 to make decisions, and then the control plane 212 instructs the forwarding plane 208 on how to move packets based on the decisions made. For example, if the control plane 212 determines that a new video channel is allowed to be joined to the multicast groups, the control plane 212 adds the new video channel to the multicast groups and instructs the forwarding plane 208 to move the packets corresponding to the new video channel from the data network 102 to the fiber link of the PON 106.

The forwarding plane 208 includes a multicast bandwidth measurement module 210 that measures the actual amount of multicast bandwidth being used on the PON 106. In some implementations, the multicast bandwidth measurement module 210 measures the current downstream multicast bandwidth utilization from the multicast GEM port. The multicast bandwidth measurement module 210 can measure the multicast bandwidth utilization periodically, for example, twice every millisecond, or at some other specified interval. In some implementations, the measurements can be performed aperiodically and triggered by certain events. For example, the measurements can be triggered by requests from the control plane 212 or triggered manually. The measurement by the multicast bandwidth measurement module 210 is generally performed irrespective of whether multicast CAC is enabled.

When multicast CAC is enabled and the measured amount of multicast bandwidth exceeds the bandwidth limit, the forwarding plane 208 provides the control plane 212 with data indicating that the bandwidth limit has been exceeded. For example, the forwarding plane 208 can set an “over bandwidth limit” flag 218 indicating that the bandwidth limit has been exceeded, and send the flag to the control plane 212. This flag can then be used, by the control plane 212, to lock the multicast table stored in the control plane 212, as described in more detail below.

In some implementations, the forwarding plane 208 may report the measured amount of multicast bandwidth to the control plane 212, and the control plane 212 can compare the measured amount of multicast bandwidth with the bandwidth limit to decide whether to lock the multicast table. In some implementations, the control plane 212 may poll the forwarding plane 208 to obtain the “over bandwidth limit” flag information or the measured amount of multicast bandwidth.

The forwarding plane 208 receives instructions from the control plane 212 that instructs the forwarding plane regarding how data packets are to be routed. For example, if the control plane 212 determines that a new video channel is allowed to join the multicast traffic on the PON, the control plane 212 sends an “allow join” indication 220 to the forwarding plane 208. The forwarding plane 208 then routes the data packets 222 of the new channel from the data network 102 to the end user device 216 through the PON. Similarly, if the control plane 212 determines that an existing channel delivered on the PON is no longer being watched, the control plane sends a “remove” indication to the forwarding plane 208 so that the forwarding plane 208 stops sending the packets of that channel to the PON.

The control plane 212 maintains a multicast table 214 that includes information related to the existing video channels (or multicast groups) being delivered over the PON. Each member of the multicast table 214 represents a multicast video channel (or a multicast group) that is being delivered over the PON. Information in the multicast table 214 may include a group address (e.g., the IP multicast group address of the channel) and a list of viewers (e.g., a list of user devices) currently associated with the channel. The multicast table 214 may also include variables that indicate whether the table is locked (e.g., based on the bandwidth limit being exceeded), as well as the number of members in the multicast table 214 when locked. The multicast table 214 may also maintain a counter to count IGMP “join” requests that were discarded, for example, due to multicast CAC enforcement (e.g., discarded when the multicast table 214 is locked).

The control plane 212 processes IGMP request 224 and other messages received from the end user device 216. For example, when an end user device 216 is tuned into a given channel, a message, such as an IGMP join request 224, is sent from the end user device 216 (or the residential gateway 114a of the user) to the control plane 212. The IGMP join request 224 will identify the given channel which the end user device was tuned into, and request that the given channel be delivered to the end user device 216. IGMP messages are referred to for purposes of example, but other messages could also be used to request the given channel.

In some implementations, the control plane 212 will compare the given channel identified in the IGMP join request 224 to the channels that are already included in the multicast table 214. When the given channel matches a channel already listed in the multicast table 214, the given channel is currently being delivered over the PON, such that additional bandwidth will not be utilized if this join request is allowed. Therefore, the control plane can send an “allow join” indication 220 to the forwarding plane 208 irrespective of the amount of actual bandwidth being used to deliver the multicast data for the channels listed in the multicast table.

When the given channel does not match a channel already listed in the multicast table 214, the given channel is not currently being delivered over the PON, and must be added to the multicast table 214. In this situation, the control plane 212 can determine whether the given channel should be added to the multicast table 214 based on the measured amount of multicast bandwidth being used to deliver multicast data corresponding to the current members of the multicast table (e.g., as measured by the multicast bandwidth measurement module 210). For example, when the measured amount of multicast bandwidth being used is below the bandwidth limit, the control plane 212 can add the given channel to the multicast table 214, and send an “allow join” indication 220 to the forwarding plane 208. In response to receiving the “allow join” indication, the forwarding plane 208 will deliver multicast data for the given channel to the user device that submitted the IGMP join request 224.

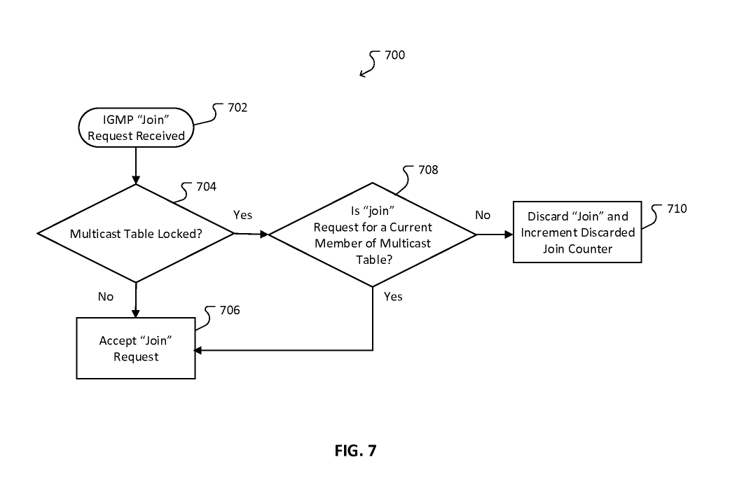

When the measured amount of multicast bandwidth is greater than the bandwidth limit, the multicast table 214 can also be locked. When the multicast table is locked, any received IGMP “join” request specifying a multicast channel that is not already a member of the table is discarded (or ignored) and a counter to count discarded IGMP “join” requests can be incremented, as discussed in more detail with reference to FIG. 7. Rejecting the join requests while the multicast table is locked prevents any new multicast channels from being added to the multicast table once the bandwidth limit is exceeded.

When the multicast table is locked, the size of the locked table can be recorded. For example, the number of members in the locked table is recorded. The control plane of the PON interface may send the size of the locked table to the network management system at the central office of the service provider to help the service provider monitor the network performance and provision the network resources. For example, if the service provider often sees a small size for the locked table, the service provide may consider to increase the bandwidth limit to allow more multicast channels on the PON.

The multicast channels that are included in the multicast table when the table was locked are not impacted by the multicast table being locked, and remain members of the multicast table. For example, as discussed above, if the multicast table is locked and a “join” request is received for an existing member of the table, then this “join” request is accepted, and the channel specified in the IGMP join request is provided to the requesting user device. If the multicast table is locked and a “join” request is received for a multicast channel that is not a member of the table, then this “join” request is denied. If the table is not locked, then all “join” requests can be accepted. After locking of the multicast table, the multicast table can be unlocked when the measured amount of multicast bandwidth falls back below the bandwidth limit. In some implementations, the measured amount of multicast bandwidth will fall back below the bandwidth limit when one or more channels are removed from the multicast table. For example, assume that all users that were watching channel A have either tuned to another channel or powered their gateways down. In this example, channel A will be removed from the multicast table (e.g., by the control plane 212) when a “leave” message is received from the last end user device 216 or residential gateway. Channel A may also be removed from the multicast table due to a timer expiry associated with an IGMP query message. The control plane 212 may send an IGMP query message to all end user devices or residential gateways associated with channel A (e.g., the viewers of channel A listed in the multicast table 214). After sending out the query message, the control plane 212 starts a timer. If the control plane 212 does not receive a response from any of the end user devices or residential gateways before the timer expires, the control plane 212 assumes that no one is watching channel A and hence remove the channel from the multicast table.

When channel A is removed from the multicast table, the control plane 212 will inform the forwarding plane 208 that channel A has been removed, and instruct the forwarding plane to no longer transmit the multicast data 208 over the PON. When the forwarding plane 208 stops transmitting the multicast data for channel A, the measured amount of multicast bandwidth, as measured by the multicast bandwidth measurement module 210, will decrease by the amount of bandwidth that was previously utilized to transmit the multicast data for channel A. As such, the forwarding plane 208 can either clear the “over bandwidth limit” flag 218, or otherwise inform the control plane 212 that the measured amount of multicast bandwidth has fallen below the threshold. In turn, the control plane 212 can unlock the multicast table 214, and continue processing join requests in the manner discussed above.

In some implementations, after the measured amount of multicast bandwidth has fallen below the bandwidth limit, the control plane 212 will unlock the multicast table 214 in response to determining that at least one member has been removed from the multicast table 214. Conditioning the unlocking of the multicast table 214 on the removal of at least one member of the multicast table 214, can help ensure that the drop in measured amount of multicast bandwidth was due to a reduction in the number of channels being delivered over the PON, rather than some other transient event (e.g., a temporary interruption in data transmission for one of the channels).

When the measured amount of multicast bandwidth is greater than the bandwidth limit, a threshold crossing alarm (TCA) can be triggered. When the TCA is triggered, the control plane 212 can send the TCA information 228 to the network management system 204 to indicate that the bandwidth limit has been exceeded. The TCA can alert the service provider (e.g., at the central office) that the bandwidth limit has been exceeded. For example, when the TCA is triggered, the OLT (or another device) can output data that causes a network management system to generate a visual or audible alarm informing the service provider that the bandwidth limit has been exceeded.

The TCA is cleared when the measured amount of multicast bandwidth remains below the bandwidth limit for some provisioned amount of time. The provisioned amount of time is called a TCA hysteresis timer. The TCA hysteresis timer is to avoid ping-pong effect when the measured amount of multicast bandwidth fluctuates around the bandwidth limit. With the TCA hysteresis timer, the TCA is not cleared until the measured amount of multicast bandwidth has been stable below the bandwidth limit. The TCA hysteresis timer is generally provisioned per PON interface. In some implementations, the default of the TCA hysteresis timer is set to 5 minutes. The valid range can be 1 to 30 minutes or some other specified amount of time.

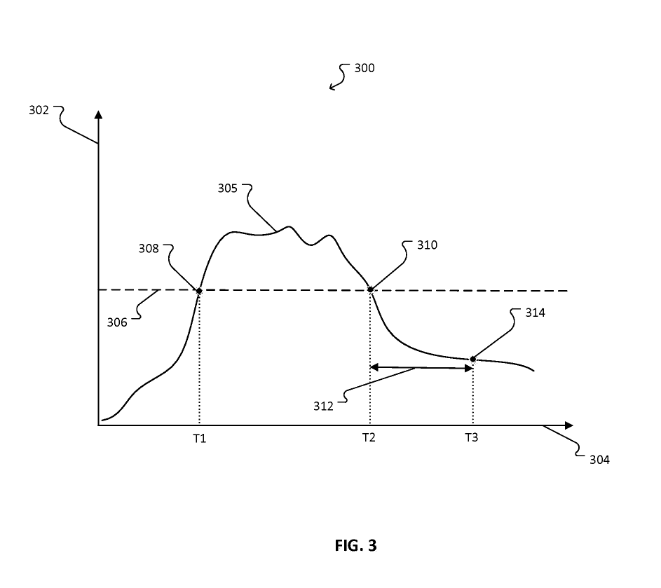

FIG. 3 is a diagram showing an example change in the measured amount of multicast bandwidth over time. The example 300 shows a y-axis 302 representing an amount of multicast bandwidth, an x-axis 304 representing a time, a curve 305 representing the measured amount of multicast bandwidth, a multicast bandwidth limit 306, and a TCA hysteresis timer 312. As the end users join and leave channels, the amount of multicast data delivered on the PON changes with time, and hence the measured amount of multicast bandwidth 305 changes with time. The variable bit rates of encoded video channels may also cause the measured amount of multicast bandwidth 305 to change with time.

At time T1 (i.e., at point 308), the measured amount of multicast bandwidth 305 reaches the bandwidth limit 306. At this point in time (or when the measured amount of multicast bandwidth exceeds the bandwidth limit 306), the control plane of the PON interface locks the multicast table and prevents any new channel from being delivered on the PON. At time T1, the control plane of the PON interface can also activate the TCA and send the information related to the TCA activation to the network management system at the central office. The information related to the TCA activation may include the measured amount of multicast bandwidth when the TCA is activated, information about the locked multicast table when the TCA is activated, and other information which may be used by the network management system to monitor network performance and provision network resources.

In some implementations, with the simplified multicast CAC, the highest amount of aggregate multicast bandwidth used is the sum of the bandwidth limit and the highest individual bandwidth among all channels. For example, assume that just prior to (or at) the point 308, a join request for a new channel was received. In this example, the multicast table has not yet been locked, so the join request will be approved, and the new channel will be added to the multicast table and delivered on the PON. As such, the actual amount of bandwidth being used will increase by the bandwidth used by the new channel, such that the aggregate multicast bandwidth used will be the sum of the bandwidth limit and the bandwidth used by the new channel.

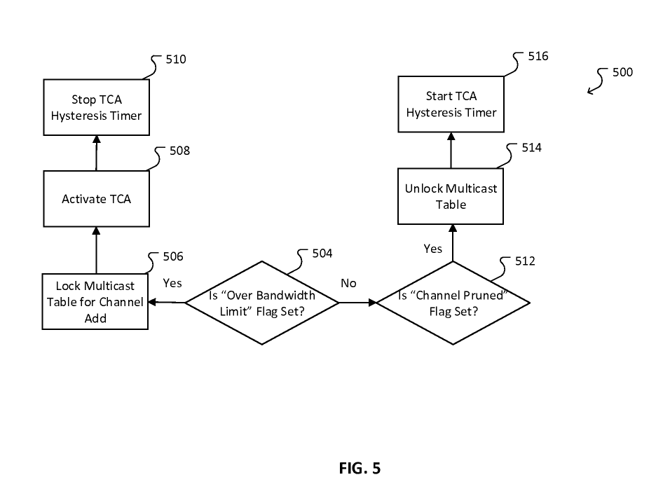

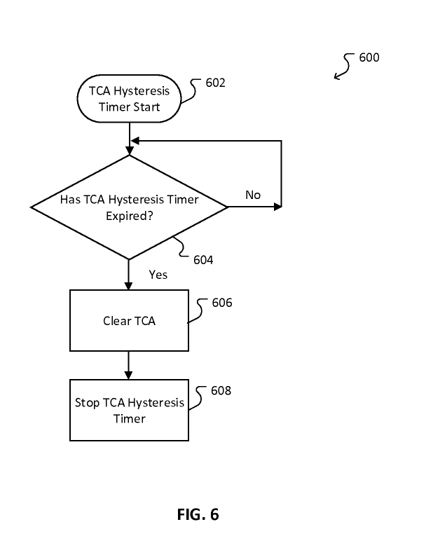

At time T2 (i.e., at point 310), the measured amount of multicast bandwidth 305 falls to (or below) the bandwidth limit 306. At this point, the control plane of the PON interface unlocks the multicast table and allows new channels to be added to the multicast table and delivered on the PON. When the measured amount of multicast bandwidth 305 is at or below the bandwidth limit 306, the control plane of the PON interface may also start a TCA hysteresis timer 312. The time duration of the TCA hysteresis timer 312 may be configured or provisioned by the service provider, for example, through the network management system. The TCA hysteresis timer is discussed in more detail with reference to FIGS. 5 and 6.

Assume, for purposes of example, that the duration of the TCA hysteresis timer corresponds to the period of time between T2 and T3 of FIG. 3. In this example, the TCA is cleared (e.g., by the control plane) when the measured amount of multicast bandwidth remains below the bandwidth limit from time T2 to time T3 because the TCA hysteresis timer will have expired.

At the expiry of the TCA hysteresis timer 312 (e.g., at time T3 or point 314), the control plane of the PON interface can also send information related to the TCA clearance to the network management system at the central office. The information related to the TCA clearance may include the measured amount of multicast bandwidth when the TCA is cleared, information about the unlocked multicast table when the TCA is cleared, the time duration from the TCA being activated (e.g., time T1) to the TCA being cleared (e.g., time T3), and other information which can be used by the network management system to monitor network performance and provision network resources. For example, if a long time duration from the TCA being activated to the TCA being cleared is often observed, it may indicate insufficient PON resources are allocated for multicast traffic, and the service provider may consider increasing the bandwidth limit or deploying more PONs. If, prior to the expiry of the TCA hysteresis timer, the measured amount of multicast bandwidth again exceeds the bandwidth limit 306, the TCA hysteresis timer is disabled, and the TCA remains active. The TCA hysteresis timer is reactivated when the measured amount of multicast bandwidth subsequently falls below the bandwidth limit 306, and the TCA will be cleared if the measured amount of multicast bandwidth 305 remains below the bandwidth limit 306 for the duration of the TCA hysteresis timer.

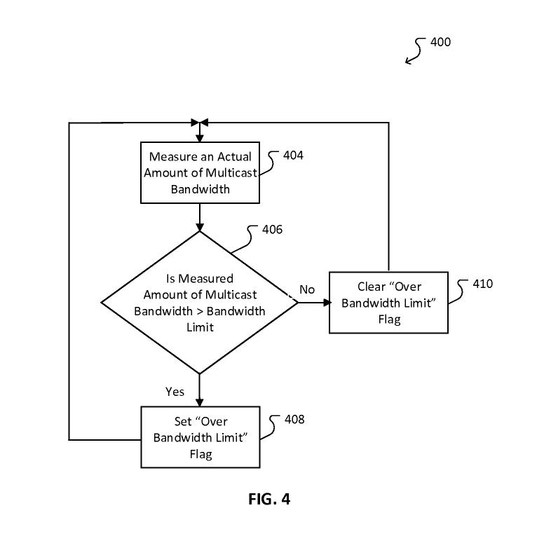

FIG. 4 is a flow chart of an example process for measuring the actual amount of utilized multicast bandwidth. Operations of the example process 400 can be performed, at least in part, by the hardware of the forwarding plane of the PON interface.

The actual amount of multicast bandwidth being used is measured at 404. In some implementations, the multicast bandwidth measurement is performed by hardware of the forwarding plane of the PON interface. For example, the multicast bandwidth measurement module 210 in the forwarding plane measures the current downstream multicast bandwidth utilization over the multicast GEM port.

The forwarding plane of the PON interface determines whether the measured amount of multicast bandwidth exceeds the bandwidth limit at 406. For example, the forwarding plane can compare the measured amount of multicast bandwidth to the bandwidth limit. The bandwidth limit can be pre-specified, for example, by an operator/administrator of the PON. If the measured amount of multicast bandwidth exceeds the bandwidth limit, at 408 the forwarding plane of the PON interface sets an “over bandwidth limit” flag and send information of the flag to the control plane of the PON interface. If the measured amount of multicast bandwidth is below the bandwidth limit, at 410 the forwarding plane of the PON interface clears the “over bandwidth limit” flag and may notify the control plane of the PON interface about the clearance of the flag. The forwarding plane of the PON interface may repeat the measurement of the actual amount of multicast bandwidth periodically and/or aperiodically.

FIG. 5 is a flow chart of an example process for updating a multicast table lock. Operations of the example process 500 can be performed, at least in part, by the control plane of the PON interface.

The control plane determines if the “over bandwidth limit” flag is set by the forwarding plane of the PON interface at 504. If the control plane determines that the “over bandwidth limit” flag is set, the control plane locks the multicast table to prevent new channels being delivered on the PON at 506. The control plane may record the number of the members of the locked multicast table when the determination is made that the “over bandwidth limit” flag is set. The control plane can also activate a TCA at 508. Additionally, the control plane stops any TCA hysteresis timer at 510 if there is a TCA hysteresis timer running

If, at 504, the control plane determines that the “over bandwidth limit” flag is not set (e.g., the measured amount of multicast bandwidth becomes below the bandwidth limit), the control plane determines if there has been a channel removed from the PON at 512 by checking a “channel pruned” flag, which is discussed in more detail below. If the “channel pruned” flag is set, the control plane unlocks the multicast table at 514 to allow new channels to be added to the multicast table and delivered on the PON. The control plane also starts the TCA hysteresis timer at 516 when the multicast table is unlocked. In some implementations, the control plane unlocks the multicast table as long as the “over bandwidth limit” flag is not set without checking (or irrespective of the state of) the “channel pruned” flag.

FIG. 6 is a flow chart of an example process for clearing a TCA hysteresis timer. Operations of the example process 600 can be performed, at least in part, by the control plane of the PON interface. According to the process 600, a TCA hysteresis timer starts at 602. The control plane determines if the TCA hysteresis timer is expired at 604. For example, the control plane can start a countdown timer when the “over bandwidth limit” flag is cleared, and the duration of the countdown timer can be set to the duration of the TCA hysteresis timer. The timer can be stopped and reset to the original duration each time that the “over bandwidth limit” flag is set, and started again each time the “over bandwidth flag” is cleared. In this example, the TCA hysteresis timer expires when the TCA hysteresis timer reaches zero.

In another example, the control plane can determine an amount of time that has elapsed since the “over bandwidth limit” flag was last cleared. For example, when the “over bandwidth limit” flag is cleared, the control plane can start a count up timer to track the time that has elapsed since the over “over bandwidth flag” was last cleared. This amount of time can be compared to the specified duration of the hysteresis timer. If the amount of time meets or exceeds the duration, then the TCA timer is determined to be expired.

If the TCA hysteresis timer is expired, the control plane clears the TCA at 606 and may notify the clearance of the TCA to the network management system at the central office of the service provide. The control plane subsequently stops the TCA hysteresis timer at 608.

FIG. 7 is a flow chart of an example process for processing an IGMP “join” request. Operations of the example process 700 can be performed, at least in part, by the control plane of the PON interface. According to the process 700, an IGMP “join” request is received at 702.

The control plane determines whether the multicast table is locked at 704. If the multicast table is unlocked, the control plane accepts the “join” message at 706. If the “join” request is for a new channel which is not a current member of the multicast table, the control plane may send an “allow join” indication to the forwarding plane so that the new channel will be delivered on the PON. If the “join” request is for a channel which is a current member of the multicast table, the control plane may also send an “allow join” indication to the forwarding plane so that the PON will deliver the multicast data to the end user device.

If the multicast table is locked, at 708 the control plane further determines whether the “join” request is for a channel which is a current member of the multicast table. If the “join” request is for a channel which is a current member of the multicast table, at 706 the control plane accepts the “join” request regardless of the locked multicast table. If the “join” request is for a channel which is not a current member of the multicast table, at 710 the control plane discards the “join” request and increment the counter that counts the number of discarded IGMP “join” requests. The control plane may send the counter information to the network management system at the central office of the service provider to help the service provider monitor the network performance and provision network resources. The counter may be reset by the network management system or the control plane of the PON interface.

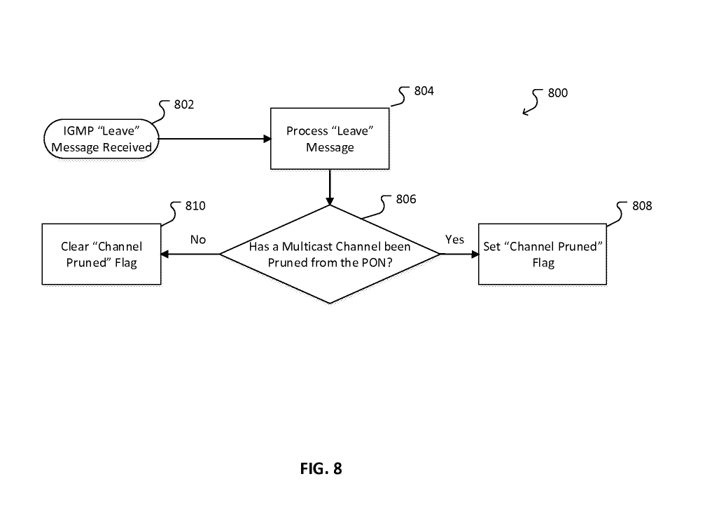

FIG. 8 is a flow chart of an example process for processing an IGMP “leave” message. Operations of the example process 800 can be performed, at least in part, by the control plane of the PON interface. According to the process 800, an IGMP “leave” message is received at 802. The control plane processes the “leave” message at 804. The control plane may update the list of end user devices for the channel that is specified in the “leave” message. If the end user device sending the “leave” message is the last end user device for the channel, the control plane removes the channel from the multicast table.

At 806, the control plane determines whether a channel has been removed from the multicast table. If a channel has been removed from the multicast table, at 808 the control plane sets the “channel pruned” flag. In some implementations, when there is a channel pruned from the multicast table, the control plane triggers an event to the forwarding plane to check if the measured amount of multicast bandwidth is below the bandwidth limit. If the measured amount of multicast bandwidth is below the bandwidth limit, the control plane may unlock the multicast table if the table was locked. If no channel has been removed from the multicast table, at 810 the control plane clears the “channel pruned” flag.

In some implementations, the control plane may perform the following logic.

```
If (current downstream multicast bandwidth > bandwidth limit)
    Activate TCA
        Lock multicast table on the PON (existing channels on the PON
continue to be delivered, however no new channels can be added
to the PON)
        Disable TCA hysteresis timer if it is running
    If (multicast table is locked AND “channels pruned” flag is set)
        If (current downstream multicast bandwidth still > bandwidth
        limit)
            Lock multicast table (now the multicast table is locked
with fewer channels)
            Disable TCA hysteresis timer if it is running
        Else
            Unlock multicast table
            Activate TCA hysteresis timer
        If (TCA hysteresis timer expires)
            Clear TCA
```

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method, comprising:
measuring, at a forwarding plane of a telecommunications device, an actual amount of multicast bandwidth being used to deliver multicast data to multiple end user devices over a telecommunications link;
controlling, by the telecommunications device, membership to the multicast table based on the measured amount of multicast bandwidth being used independent of the amount of bandwidth or type of bandwidth used by any individual member of the multicast table and a threshold amount of bandwidth, and
transmitting, by the telecommunications device, the multicast data to user devices that have requested the multicast data corresponding to a member of the multicast table.

2. The method of claim 1, further comprising:
determining that the measured amount of multicast bandwidth being used exceeds the threshold amount of bandwidth; and
activating a threshold crossing alarm (TCA) in response to determining that the measured amount of multicast bandwidth being used exceeds the threshold amount.

3. The method of claim 2, wherein activating the TCA comprises transmitting data that causes a network management system to generate a visual or audible alarm indication.

4. The method of claim 2, further comprising:
determining that the measured amount of multicast bandwidth being used is below the threshold amount; and
maintaining the TCA until the measured amount of multicast bandwidth has been below the threshold amount for at least a specified period of time.

5. The method of claim 1, wherein:
the telecommunications link is a passive optical network (PON); and
the multicast data is video data.

6. The method of claim 1, wherein measuring the actual amount of multicast bandwidth being used comprises determining a current downstream bandwidth utilization from a multicast gigabit PON encapsulation method (GEM) port.

7. The method of claim 1, wherein each member of the multicast table represents a multicast video channel.

8. The method of claim 1, wherein controlling membership to the multicast table based on the measured amount of multicast bandwidth and the threshold amount of bandwidth further comprising:
preventing new members from being added to the multicast table when the measured amount of multicast bandwidth exceeds the threshold amount of bandwidth; and
allowing new members to be added to the multicast table when the measured multicast bandwidth does not exceed the threshold amount of bandwidth.

9. The method of claim 8, wherein preventing new members from being added comprises discarding join requests from user devices when a multicast channel specified in the join request is not already a member of the multicast table.

10. The method of claim 8, further comprising, when the amount of multicast bandwidth being used exceeds the threshold amount of bandwidth, accepting join requests from user devices when a multicast channel specified in the request is already a member of the multicast table.

11. The method of claim 1, wherein the type of bandwidth used by individual member of the multicast table is at least one of variable bandwidth or constant bandwidth.

12. The method of claim 1, wherein the threshold amount of bandwidth can be changed at any time.

13. A telecommunications device, comprising:
a forwarding plane that delivers multicast data to multiple end user devices over a telecommunications link; and
a control plane that controls delivery of multicast data by the forwarding plane, wherein
the forwarding plane measures an actual amount of multicast bandwidth being used to deliver multicast data to multiple end user devices over a telecommunications link and reports the amount of multicast bandwidth being used to the control plane;
the control plane controls membership to a multicast table based on the measured amount of multicast bandwidth being used and a threshold amount of bandwidth.

14. The telecommunications device of claim 13, wherein the control plane further:
determines that the measured amount of multicast bandwidth exceeds the threshold amount of bandwidth; and
activates a threshold crossing alarm (TCA) in response to determining that the measured amount of multicast bandwidth exceeds the threshold amount.

15. The telecommunications device of claim 14, wherein the control plane activating the TCA comprises transmitting data that causes a network management system to generate a visual or audible alarm indication.

16. The telecommunications device of claim 13, wherein the control plane further:
determines that the measured amount of multicast bandwidth is below the threshold amount; and
maintains the TCA until the measured amount of multicast bandwidth has been below the threshold amount for at least a specified period of time.

17. The telecommunications device of claim 13, wherein:
the telecommunications link is a passive optical network (PON); and
the multicast data is video data.

18. The telecommunications device of claim 13, wherein the forwarding plane measuring the actual amount of multicast bandwidth being used comprises determining a current downstream bandwidth utilization from a multicast gigabit PON encapsulation method (GEM) port.

19. The telecommunications device of claim 13, wherein each member of the multicast table represents a multicast video channel.

20. The telecommunications device of claim 13, wherein the control plane controlling membership to a multicast table based on the measured amount of multicast bandwidth and the threshold amount of bandwidth further comprising:
preventing new members from being added to the multicast table when the measured amount of multicast bandwidth exceeds the threshold amount of bandwidth; and
allowing new members to be added to the multicast table when the measured multicast bandwidth does not exceed the threshold amount of bandwidth.
